(19) United States
(12) Patent Application Publication
(10) Pub. No.: US 2002/0177407 A1
(43) Pub. Date: Nov. 28, 2002

(54) Portable telephone set and IC card

(75) Inventor: Hiroki Mitsumoto, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 09/968,807

(22) Filed: Oct. 3, 2001

(30) Foreign Application Priority Data
May 23, 2001 (JP) 2001-154219

(51) Int. Cl. H04B 5/00

(52) U.S. Cl. 455/41; 455/42; 455/513

(57) ABSTRACT

The IC card includes a non-contact type I/F section 32 for performing transmission/reception of data with an electronic ticket system 80 via a radio link R2 for IC card and a contact-type I/F section operating independently of the non-contact type I/F section 32, for performing transmission/reception of data via a physical contact is mounted. The portable telephone set includes a contact type IC card reader/writer 23 for performing read/write control of data with respect to the IC card 30 via the contact and the contact-type I/F section.

### FIELD OF THE INVENTION

The present invention relates to a portable telephone set equipped with an IC (Integrated Circuit) card used for various kinds of services as well as conversation. More particularly, this invention relates to a portable telephone set equipped with an IC card having both of a contact type function and a non-contact type function with simple configuration and low cost.

### BACKGROUND OF THE INVENTION

In recent years, portable telephones have explosively become widespread as the result of price cut of telephone rates and satisfaction of Internet connecting services. Furthermore, in addition to being used as communication means, portable telephones are expected to be used as general electronic tools such as electronic commerce means, electronic ticket using means and the like.

From up to now, application of an IC card to a portable telephone set have been considered. The representative of such application is an IC card called a SIM (Subscriber Identity Module) built in a portable telephone set compliant with the GSM (Global System for Mobile network) standard which is now widely used in the Europe and the Asia region except for Japan.

In early stages, SIM was only used for the purpose of making identification of a subscriber by a telecommunication carrier. However, since it becomes possible to equip an IC card with applications such as debit card facility and credit card facility in association with development in performance of IC card, SIM has come into use for services using a portable telephone set such as mobile banking.

Furthermore, also in the IMT-2000 standard which is the next-generation portable telephone standard that is planed to come into commercialized service from 2001 in Japan, an IC card called a UIM (User Identity Module) is decided to be mounted as standard to a portable telephone set. Therefore, also in Japan, preparation for practical use of services using a portable telephone set and an IC card into is getting ready.

IC cards are generally divided into two types: contact type IC cards and non-contact IC cards. Contact type IC cards have a physical contact through which exchange of data with an external device is made. Such contact type IC cards are now mainstream of IC cards in financial services.

On the other hand, non-contact type IC cards have an antenna in place of a physical contact with an external device, and enables exchange of data with an external device through this antenna by means of radio wave. IC cards of this non-contact type are widely used as IC cards in transportation services (electronic pass and electronic prepaid card, for example).

Also other IC cards have been conventionally known such as hybrid type IC card in which two IC chips, i.e., an IC chip corresponding to the contact type and an IC chip corresponding to the non-contact type are mounted in a single IC card, and a combination type IC card equipped with interfaces of both the contact type and the non-contact type in a single chip.

By the way, as described above, the conventional contact type IC card and non-contact type IC card differ from each other in the fields that they are specialized in (financial services, transportation services). Therefore, in the case of integrating an IC card in a portable telephone set, it is desired that the portable telephone set has two interfaces for a contact type IC card and for a non-contact type IC card.

In such a case, however, it is necessary to provide the portable telephone set with two sets of IC card reader/writer for achieving read/write with respect to each of the contact type IC card and the non-contact type IC card, with the result that configuration of the portable telephone set is complicated and the cost is increased.

In view of the above, an approach may be considered such that an IC card having interfaces for both the contact type and the non-contact type is integrated in the portable telephone set. However, in this approach, in the case of an IC card having a size (credit card size) compliant with the ISO (International Organization for Standardization) standard, there arises a problem that the card cannot be accommodated in the portable telephone set. On the other hand, in the case of SIM as described above, a problem arises that there is not an enough space on the card to accommodate an antenna.

### SUMMARY OF THE INVENTION

The present invention relates to a portable telephone set capable of mounting an IC card having functions of both the contact type and the non-contact type with simple configuration and low cost, and readily receiving various kinds of services using the portable telephone set.

The portable telephone set according to one aspect of the present invention comprises an IC card having a non-contact type interface for performing transmission/reception of data with an external system via a radio link and a contact type interface operating independently of the non-contact type interface, for performing transmission/reception of data via a physical contact; and a portable telephone body on which the IC card is mounted, having a contact type reader/writer for performing read/write control of data with respect to the IC card via the contact and the contact type interface.

According to the present invention, since the IC card has both of the non-contact type interface and the contact type interface which operates independently of the non-contact type interface and performs transmission/reception of data via the physical contact, and the contact type reader/writer for performing read/write control of data with respect to the IC card via the contact and the contact type interface is provided, the necessity of providing a non-contact type reader/writer on the portable telephone body side as is in the conventional case is eliminated, making it possible to mount the IC card with simple configuration and low cost.

Other objects and features of this invention will become apparent from the following description with reference to the accompanying drawings.

### BRIEF DESCRIPTION OF THE DRAWINGS

FIG. 1 is a perspective view showing an outer configuration of one embodiment according to the present invention;

FIG. 2 is a block diagram showing an electric configuration of the portable telephone set 10 shown in FIG. 1;

FIG. 3 is a block diagram showing an electric configuration of the IC card 30 shown in FIG. 1;

FIG. 4 is a view for explaining the operation at the time of downloading an electronic ticket in first application example of the same one embodiment;

FIG. 5 is a view for explaining the operation at the time of using an electronic ticket in first application example of the same one embodiment;

FIG. 6 is a view for explaining the operation at the time of presenting service points in second application example of the same one embodiment; and

FIG. 7 is a view for explaining the operation at the time of using service points in second application example of the same one embodiment.

### DESCRIPTION OF THE PREFERRED EMBODIMENTS

Embodiment of the portable telephone set according to the present invention will be described in detail with reference to the drawings.

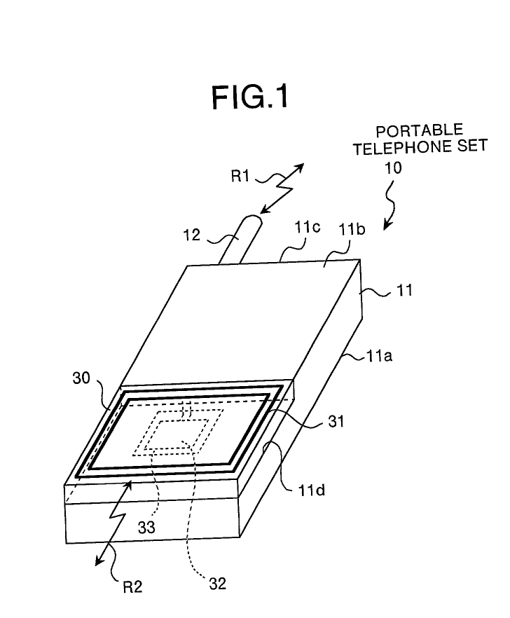

FIG. 1 is a block diagram showing an outer configuration of one embodiment according to the present invention. FIG. 1 shows a portable telephone set 10 viewed from the rear face side. This portable telephone set 10 is carried by a user, connectable, for example, to a network for mobile communication (not shown) via a radio link R1 of 1.5 GHz band, and equipped with a voice communication function for realizing telephone conversation with a party on the ground side, a data communication function for downloading data from a server connected to the network and the like, and an IC card interface function for interfacing with an IC card 30 which will be described below.

In the portable telephone set 10, a housing 11 is formed by shaping a synthetic resin into a roughly box shape. Inside the housing 11 are mounted an electronic circuit for realizing the voice communication function, data communication function and IC card function. On a surface 11a of the housing 11 are mounted a key section consisting of a plurality of keys to be used for input of telephone number and selection of function in data communication, a display for displaying a conversation state, a state of data communication and the like, a microphone, a speaker and the like.

Furthermore, in the lower half of a back surface 11b of the housing 11 is formed a stepwise fitting portion lid into which the IC card 30 described below is to be fitted. An antenna 12 is provided at the top portion 11c of the housing 11, and transmits or receives voice data of voice communication or packet data of data communication via the radio link R1. The IC card 30 is, for example, a card to be used in using of electronic tickets or service points which will be described below, and is provided in the fitting portion lid in a detachable manner.

This IC card 30 comprises a memory for storing information of the above-mentioned electronic tickets or service points, a CPU (Central Processing Unit) for performing interface control with respect to the external and access control to the memory and the like. Furthermore, the IC card 30 is provided with an IC card antenna 31, a non-contact type I/F (interface) portion 32, a physical contact 33 and the like.

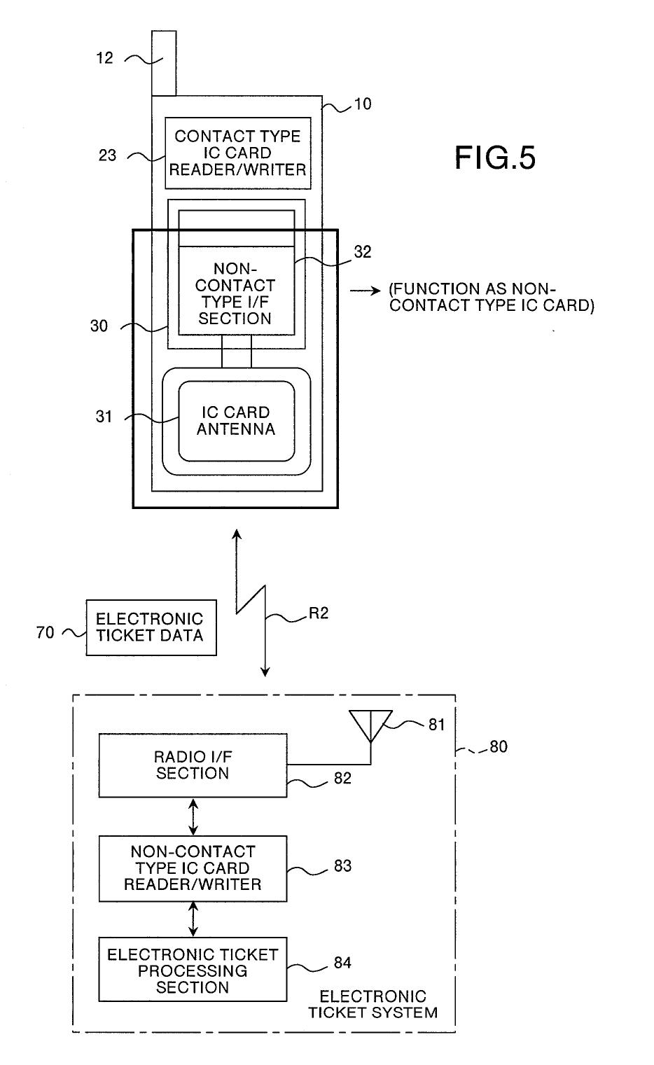

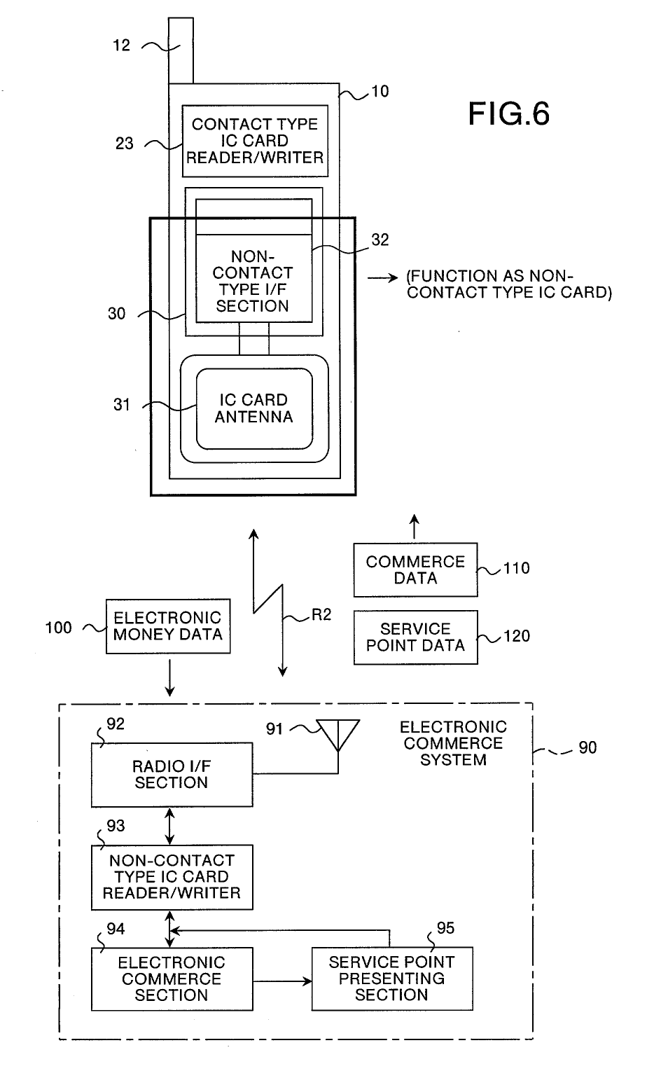

The IC card antenna 31 performs transmission/reception of data regarding use of an electronic ticket or the like with an external system (not shown) via a radio link R2 for IC card, and is intended to realize a non-contact type interface. Examples of the above external system include an electronic ticket system 80 (see FIG. 5), an electronic commerce system 90 (see FIG. 6) and the like which will be described below. The non-contact type I/F portion 32 provides an interface of data transmission/reception using the IC card antenna 31.

On the other hand, the contact 33 is electrically connected with a contact (not shown) of the portable telephone set 10, and intended to realize a contact type interface. In this way, the IC card 30 has both of the function as a non-contact type IC card and the function as a contact type IC card.

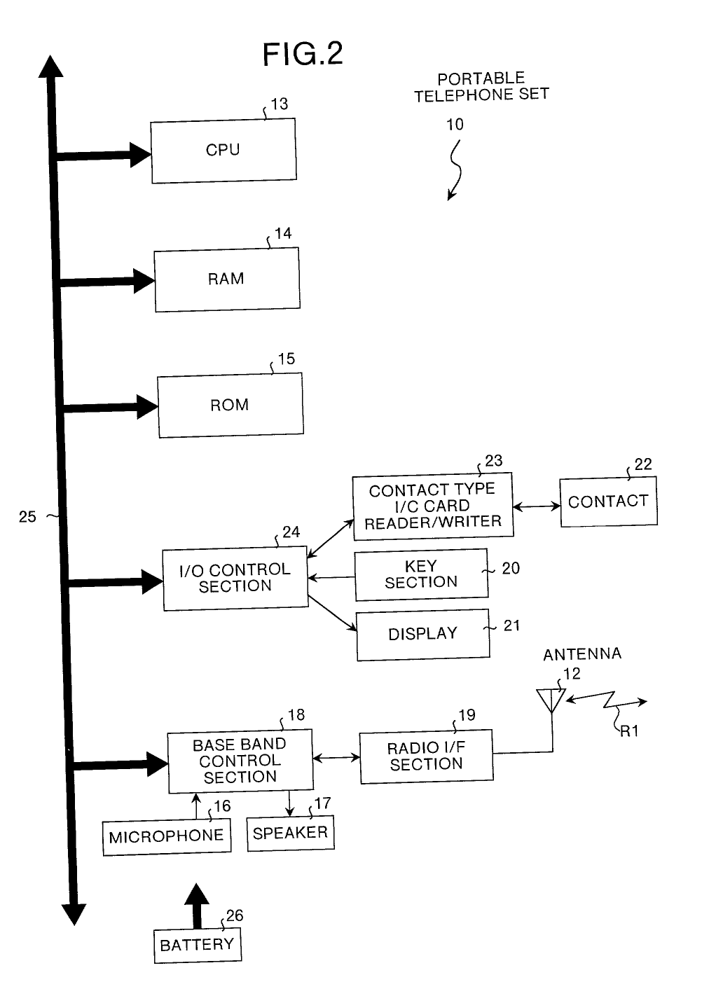

FIG. 2 is a block diagram showing an electric configuration of the portable telephone set 10 shown in FIG. 1. In FIG. 2, the parts corresponding to the respective parts in FIG. 1 are denoted by the same reference numerals. The CPU 13 shown in FIG. 2 controls each part, and performs control of data communication, interface control with the IC card 30 (see FIG. 1), memory access control and the like. Details of operation of this CPU 13 will be described later.

A RAM (Random Access Memory) 14 is a readable/writable memory, and temporarily stores data to be processed in the CPU 13. A ROM (Read Only Memory) 15 is a read only memory, and stores a computer program to be executed in the CPU 13 and various parameters. A microphone 16 is provided on the surface 11a (see FIG. 1), and has a function of converting user's voice in voice communication into voice data.

A speaker 17 is provided on the surface 11a (see FIG. 1), and has a function of converting voice data of the counter party received via the antenna 12 into a voice. A base band control section 18 has a function of modulating transmission data and function of demodulating reception data received via the antenna 12. A radio I/F section 19 is interposed between the base band control section 18 and the antenna 12, and provides an interface for radio communication.

A key section 20 is provided on the surface 11a (see FIG. 1), and consists of a plurality of keys to be used for input of telephone number and selection of function in data communication. A display 21 is provided on the surface 11a (see FIG. 1), and displays a conversation state, a state of data communication and the like. A contact 22 is brought into direct contact with the contact 33 when the IC card 30 shown in FIG. 1 is attached to the fitting portion lid, and intended to make the IC card 30 function as a contact type IC card.

A contact type IC card reader/writer 23 reads data from the IC card 30 and writes data to the IC card 30 via the contact 22. An I/O control section 24 is interposed between the display 21, the key section 20 and the contact type IC card reader/writer 23, and a bus 25, and performs input/output control of data. The bus 25 connects each part. A battery 26 is a chargeable secondary battery, and supplies each part with electric power.

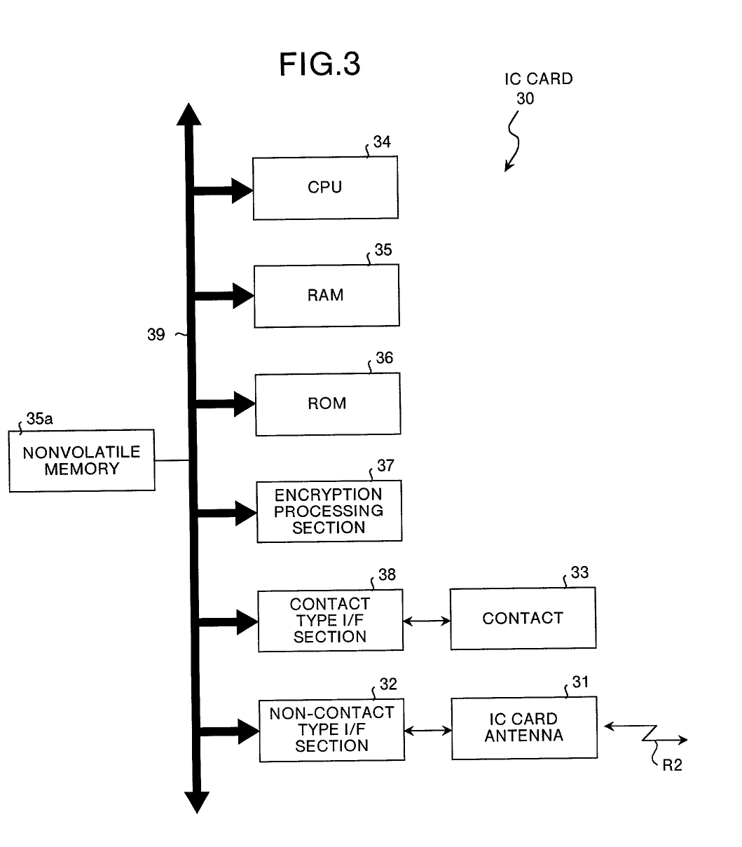

FIG. 3 is a block diagram showing an electric configuration of the IC card 30 shown in FIG. 1. In FIG. 3, the parts corresponding to the respective parts of FIG. 1 will be denoted by the same reference numerals. As described above, the IC card antenna 31 shown in FIG. 3 transmits or receives data regarding use of an electronic ticket or the like with the external system (not shown) via the radio link R2 for IC card, and is intended to realize a non-contact type interface.

As described above, the non-contact type I/F section 32 provides an interface of data transmission/reception with the external system (not shown) using the IC card antenna 31. The contact 33 is electrically connected to the contact 22 (see FIG. 2) of the portable telephone set 10, and intended to realize a contact type interface.

A CPU 34 controls each part, and performs control of data communication with the portable telephone set 10 (see FIG. 1) and with the external system (not shown), and memory access control. Details of operation of this CPU 34 will be described later. A RAM 35 is a readable/writable memory, and temporarily stores data to be processed in the CPU 34. A nonvolatile memory 35a is a memory capable of storing data upon turning off the power, and stores data of electronic ticket, service point and the like as described above.

A ROM 36 is a read only memory, and stores a program to be executed by the CPU 34 and various parameters. An encryption processing section 37 performs encryption and decryption of data in data communication between the IC card 30 and the portable telephone set 10 (or external system) A contact type I/F section 38 is interposed between a bus 39 and the contact 33, and provides an interface of data transmission/reception with the portable telephone set 10 (see FIG. 1) using the contact 33. This contact type I/F section 38 operates independently of the non-contact type I/F section 32. The bus 39 mutually connects each part.

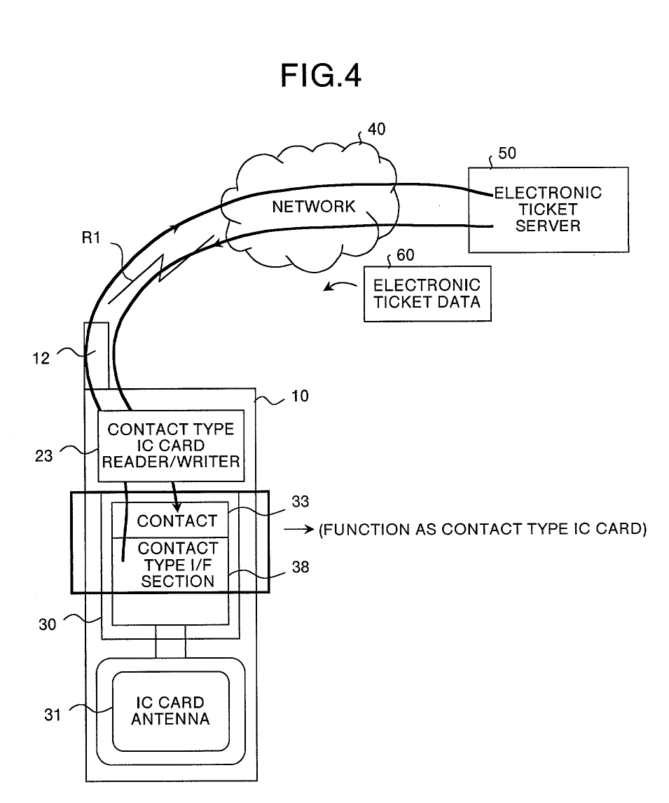

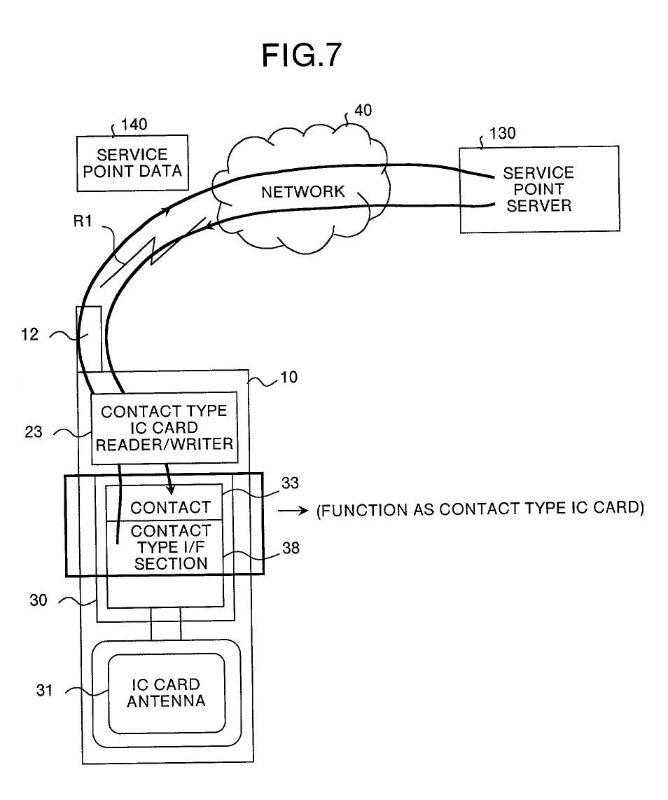

Next, application examples and operation of the portable telephone set will be explained with reference to FIG. 4 to FIG. 7. FIG. 4 and FIG. 5 are for explaining a first application example, and FIG. 6 and FIG. 7 are for explaining a second application example.

To begin with, the first application example will be described in detail with reference to FIG. 4 and FIG. 5. This first application example is an example where after an electronic ticket which is an electronified concert ticket, theater ticket or the like is downloaded (purchased) using the portable telephone set 10 and the IC card 30 (see FIG. 1), the electronic ticket is used.

The parts that perform same or similar functions as the parts shown in FIG. 1 to FIG. 3 are denoted by the same reference numerals. FIG. 4 is a view for explaining the operation at the time of downloading an electronic ticket in the first application example. A network 40 shown in FIG. 4 consists of a radio base station, a mobile network and the Internet, and is connected to the portable telephone set 10 via the radio link R1.

An electronic ticket server 50 is a server having a function of selling the electronic ticket, in accordance with the request of purchase from the portable telephone set 10, and provides the portable telephone set 10 with electronic ticket data 60 via the network 40 and the radio link R1.

FIG. 5 is a view for explaining the operation at the time of using the electronic ticket in the first application example. An electronic ticket system 80 shown in FIG. 5 is provided at the entrance of a concert place or a theater, and is a system for inspecting electronic tickets. In this electronic ticket system 80, an antenna 81 is intended to perform transmission/reception of data with the IC card antenna 31 via the radio link R2 for IC card.

A radio I/F section 82 has a function of modulating/demodulating data. A non-contact type IC card reader/writer 83 reads data (electronic ticket data 70 in FIG. 5) from the IC card 30 and writes data to the IC card 30 via the radio link R2 for IC card. An electronic ticket processing section 84 executes inspection processing of electronic ticket based on the electronic ticket data 70.

In FIG. 4, when a user of the portable telephone set 10 purchases an electronic ticket, the user inputs an URL (Uniform Resource Locator) of the electronic ticket server 50 using the key section 20 of the portable telephone set 10 (see FIG. 2), and thereafter makes connecting operation to the network 40. As a result of this, the CPU 13 of the portable telephone set 10 outputs the above URL and data for connection processing to the base band control section 18 via the bus 25.

The data is transmitted from the antenna 12 via the radio I/F section 19, and via the radio link R1 and the network 40, connection between the portable telephone set 10 and the electronic ticket server 50 is established, and a screen for purchase of electronic ticket is displayed on the display 21.

The user makes operation using the key section 20 for purchasing a desired electronic ticket. As a result of this, the purchase request of electronic ticket from the portable telephone set 10 is transmitted to the electronic ticket server 50 via the radio link R1 and the network 40, and the electronic ticket data 60 corresponding to the electronic ticket is downloaded to the portable telephone set 10 from the electronic ticket server 50.

The electronic ticket data 60 is input into the contact type IC card reader/writer 23 through the antenna 12, the radio I/F section 19, the base band control section 18 and the bus 25 and the I/O control section 24 shown in FIG. 2 controlled by the CPU 13. As a result of this, the contact type IC card reader/writer 23 outputs the electronic ticket data 60 to the contact type I/F section 38 via the contact 22 and the contact 33 shown in FIG. 3. In this way, the IC card 30 functions as a contact type IC card at the time of downloading of the electronic ticket.

The CPU 34 stores the electronic ticket data 60 input into the contact type I/F section 38 into the nonvolatile memory 35a via the bus 39. Then, the user operates the key section 20 to release the connection between the portable telephone set 10 and the electronic ticket server 50, thereby completing the purchase processing of the electronic ticket.

The user who has purchased the electronic ticket goes to the concert place while carrying the portable telephone set 10, and takes out the portable telephone set 10 near the electronic ticket system 80 provided at the entrance. Then, the user holds the portable telephone set 10 over the antenna 81 of the electronic ticket system 80 shown in FIG. 5.

As a result, the radio link R2 for IC card is established between the antenna 81 and the IC card antenna 31, and a data read request from the non-contact type IC card reader/writer 83 is transmitted to the CPU 34 via the non-contact type I/F section 32 and the bus 39 shown in FIG. 3. The CPU 34 reads the electronic ticket data stored in the nonvolatile memory 35a (see FIG. 4), and outputs the data to the non-contact type I/F section 32 via the bus 39.

After being transmitted to the electronic ticket system 80 as the electronic ticket data 70 shown in FIG. 5 via the IC card antenna 31, this electronic ticket data is read by the non-contact type IC card reader/writer 83 via the antenna 81 and the radio I/F section 82, and thereafter input into the electronic ticket processing section 84. In this way, the IC card 30 functions as a non-contact type IC card at the time of using the electronic ticket.

The electronic ticket processing section 84 identifies the electronic ticket data 70 and opens an inspection door (not shown) for allowing entry to the concert place. Then, the user enters the concert place through the inspection door and enjoys the concert.

Next, the second application example will be described in detail with reference to FIG. 6 and FIG. 7. This second application example is an example in which when a user of the portable telephone set 10 purchases goods at a store adaptable to electronic commerce using the portable telephone set 10 and the IC card 30, service points in proportion to the purchase amounts are added, and the user uses the service points later. Using the Service points, customers can receive present goods or discount at the store in correspondence with the number of points.

In FIGS. 6 and 7, the parts corresponding to the respective parts in FIGS. 1 to 3 are denoted by the same reference numerals. FIG. 6 is a view for explaining the operation at the time of presenting service points in the second application example. In FIG. 6, electronic money data 100 is data for electronic commerce, and has a function equivalent to that of cash.

In the second application example, the nonvolatile memory 35a shown in FIG. 3 stores electronic money data. Commerce data 110 is data for electronic commerce for subtracting purchase amounts from electronic money data stored in the nonvolatile memory 35a. Service point data 120 is data regarding service points to be presented to the user in accordance with the purchase amounts of goods.

The electronic commerce system 90 is provided at a store where electronic commerce is available for purchase of goods, and equipped with a function of performing electronic commerce by means of the electronic money data 100 and a function of presenting service points in proportion to purchase amounts of goods. Further, the electronic commerce system 90 communicates with the IC card 30 via the radio link R2 for IC card.

In this electronic commerce system 90, an antenna 91 performs transmission/reception of data with the IC card antenna 31 via the radio link R2 for IC card. A radio I/F section 92 has a function of modulating/demodulating data. A non-contact type IC card reader/writer 93 reads data (the electronic money data 100 in FIG. 6) from the IC card 30 and writes data (the commerce data 110 and the service point data 120 in FIG. 6) to the IC card 30 via the radio link R2 for IC card.

An electronic commerce processing section 94 executes the processing of electronic commerce, that is, generating the commerce data 110, and drawing the purchase amounts from the bank account of the user in accordance with the electronic money data 100. A service point presenting section 95 has a function of presenting the service points to the user in accordance with the purchase amounts which have been electronically debited by the electronic commerce section 94. Furthermore, the service point presenting section 95 generates the service point data 120 corresponding to the service points.

FIG. 7 is a view for explaining the operation at the time of using the service points in the second application example. A service point server 130 shown in FIG. 7 is a server which is connected to the network 40 and has a function of presenting goods to the user in accordance with the service points.

In FIG. 6, when a user of the portable telephone set 10 brings goods into a register of the store, a cashier keeps the portable telephone set 10 from the user, and holds the portable telephone set 10 over the antenna 91 of the electronic commerce system 90 shown in FIG. 6. As a result of this, the radio link R2 for IC card is established between the antenna 91 and the IC card antenna 31.

Next, upon input of purchase amounts of the goods by the cashier using an input device which is not shown in the drawing, the electronic commerce section 94 generates the commerce data 110 corresponding to the purchase amounts, and outputs this data to the non-contact type IC card reader/writer 93. In response to this, the non-contact type IC card reader/writer 93 issues a read/write request to the CPU 34 via the radio I/F section 92, the antenna 91, the radio link R2 for IC card, the IC card antenna 31 shown in FIG. 3 and the non-contact type I/F section 32.

The CPU 34 stores the commerce data 110 in the RAM 35, while subtracting the purchase amounts corresponding to the commerce data 110 from the electronic money data stored in advance in the nonvolatile memory 35a. Subsequently, the CPU 34 outputs the electronic money data 100 corresponding to the purchase amounts to the non-contact type I/F section 32 via the bus 39.

As a result of this, the electronic money data 100 is input into the electronic commerce section 94 via the IC card antenna 31, the radio link R2 for IC card shown in FIG. 6, the antenna 91, the radio I/F section 92 and the non-contact type IC card reader/writer 93. The electronic commerce section 94 performs electronic commerce processing, that is, drawing the purchase amounts from the bank account and the like of the user in accordance with the electronic money data 100. Furthermore, the electronic commerce section 94 outputs the data of the purchase amounts to the service point presenting section 95.

The service point presenting section 95 presents the user with service points in proportion to the purchase amounts. To be more specific, the service point presenting section 95 generates the service point data 120 corresponding to the service points and outputs this data to the non-contact type IC card reader/writer 93. As a result of this, the service point data 120 is input into the non-contact type I/F section 32 shown in FIG. 3 via the radio I/F section 92, the radio link R2 for IC card and the IC card antenna 31.

This service point data 120 is stored in the nonvolatile memory 35a under control of the CPU 34. Subsequent to this, wherever the user purchases some goods at a store having provision for electronic commerce, the operation of presenting service points is repeated, resulting in accumulation of service points.

A case in which a user uses the service points that have accumulated to a certain extent will be explained with reference to FIG. 7. In this case, the user inputs an URL of the service point server 130 using the key section 20 of the portable telephone set 10 (see FIG. 2), and thereafter performs connecting operation to the network 40. As a result of this, the CPU 13 in the portable telephone set 10 outputs the URL and data for connecting processing to the base band control section 18 via the bus 25.

The data is transmitted from the antenna 12 via the radio I/F section 19, and via the radio link R1 and the network 40, connection between the portable telephone set 10 and the service point server 130 is established, and a screen for using the service points is displayed on the display 21.

The user performs operation of, for example, acquiring present goods in accordance with to the service points using the key section 20. As a result of this, the CPU 13 of the portable telephone set 10 show in FIG. 2 issues a data read request to the contact type IC card reader/writer 23 via the bus 25 and the I/O control section 24. In response to this, the contact type IC card reader/writer 23 issues the request to the CPU 34 via the contact 22, the contact 33, the contact type I/F section 38 and the bus 39 shown in FIG. 3.

In response to this, the CPU 34 reads service point data from the nonvolatile memory 35a, and outputs this data to the contact type IC card reader/writer 23 via the bus 39, the contact type I/F section 38, the contact 33 and the contact 22 shown in FIG. 2. This service point data is transmitted under control of the CPU 13 to the service point server 130 as service point data 140 via the I/O control section 24, the base band control section 18, the radio I/F section 19, the antenna 12, the radio link R1 and the network 40 shown in FIG. 7.

Upon reception of the service point data 140, the service point server 130 executes processing for sending the present goods in accordance with the service point data 140 to the user. Then, the connection between the portable telephone set 10 and the service point server 130 is released by operation of the key section 20 by the user to complete the using processing of service points.

As described above, according to one embodiment, since the IC card 30 has both of the non-contact type I/F section 32 shown in FIG. 3 and the contact type I/F section 38 which operates independently of the non-contact type I/F section 32 and performs transmission/reception of data via the physical contact 33, and the portable telephone set 10 has the contact type IC card reader/writer 23 (see FIG. 2) which performs read/write control with respect to the nonvolatile memory 35a via the contact 33 and the contact type I/F section 38, the necessity of providing a non-contact type reader/writer on the side of the portable telephone set body as is in the conventional case is eliminated, with the result that it is possible to mount an IC card with simple configuration and low cost.

Furthermore, since under control of the CPU 13 of the portable telephone set 10 shown in FIG. 2, the electronic ticket data 60 supplied via the network 40 (see FIG. 4) is stored in the nonvolatile memory 35a via the contact 33 and the contact type I/F section 38 shown in FIG. 3, and the electronic ticket data 60 stored in the nonvolatile memory 35a is read as the electronic ticket data 70 by the non-contact type IC card reader/writer 83 of the electronic ticket system 80 shown in FIG. 5 via the radio link R2 for IC card, the user can easily receive various kinds of services (electronic ticket, for example) in accordance with the ticket data 60 supplied via the network 40 while allowing the non-contact type I/F section 32 and the contact type I/F section 38 to operate independently.

Furthermore, the electronic commerce system 90 shown in FIG. 6 writes the service point data 120 and the like into the nonvolatile memory 35a via the radio link R2 for IC card and the non-contact type I/F section 32 shown in FIG. 3, and the contact type IC card reader/writer 23 shown in FIG. 2 reads the service point data 120 and the like stored in the nonvolatile memory 35a via the contact type I/F section 38 and the contact 33, and thereafter as shown in FIG. 7, the service point data 120 is transmitted to the service point server 130 on the network 40 as the service point data 140. Accordingly, the user can easily receive various kinds of services (present goods, for example) in accordance with the service point data 140 supplied via the network 40 while allowing the non-contact type I/F section 32 and the contact type I/F section 38 to operate independently.

In the above, while detailed explanation has been made for one embodiment of the present invention with reference to the drawings, the concrete example of configuration is not limited to this one embodiment, and any design modifications and the like can be included in the present invention so far as they do not depart from the scope of the invention. For example, explanation on the above-described one embodiment was made for two application examples in respect of electronic ticket and service point, respectively, however, the present invention can be applied to various kinds of services which make use of electronic measures without limited to these examples.

As describe above, according to the present invention, since the IC card has both of the non-contact type interface and the contact type interface operating independently of the non-contact type interface, for performing transmission/reception of data via the physical contact, and the contact type reader/writer for performing read/write control of data with respect to the IC card via the contact and the contact type interface is provided, the necessity of providing a non-contact type reader/writer on the portable telephone body side as is the conventional case is eliminated, so that an advantage such that the IC card can be mounted with simple configuration and low cost is achieved.

Furthermore, since the data supplied via the mobile network under control of the communication control section is stored in the memory section via the contact and the contact type interface, and the data stored in the memory section is read by the external system via the radio link and the non-contact type interface, an advantage is achieved such that the user can easily receive, for example, various kinds of services corresponding to the above data supplied via the mobile network while allowing the contact type interface and the non-contact type interface to operate independently.

Furthermore, since data is written in the memory section by the external system via the radio link and the non-contact type interface, and after the data stored in the memory section is read by the contact type reader/writer control section via the contact type interface and the contact, the data is transmitted to the mobile network, an advantage is achieved such that the user can easily receive, for example, various kinds of services corresponding to the above data supplied via the mobile network while allowing the contact type interface and the non-contact type interface to operate independently.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A portable telephone set comprising:
an IC card having a non-contact type interface for performing transmission/reception of data with an external system via a radio link and a contact type interface operating independently of the non-contact type interface, for performing transmission/reception of data via a physical contact; and
a portable telephone body on which the IC card is mounted, having a contact type reader/writer for performing read/write control of data with respect to the IC card via the contact and the contact type interface.

2. The portable telephone set according to claim 1, wherein the IC card has a memory section for storing data; the portable telephone body has a communication control section for performing voice/data communication via a mobile network; the contact type reader/writer control section stores data supplied via the mobile network under control of the communication control section into the memory section via the contact and the contact type interface; and the data stored in the memory section is read by the external system via the radio link and the non-contact type interface.

3. The portable telephone set according to claim 2, wherein the data supplied via the mobile network is various kinds of service data for the user to receive various kinds of services.

4. The portable telephone set according to claim 2, wherein the data supplied via the mobile network is electronic ticket data.

5. The portable telephone set according to claim 1, wherein the IC card has a memory section for storing data; the portable telephone body has a communication control section for performing voice/data communication via the mobile network; the external system writes data into the memory section via the radio link and the non-contact type interface; the contact type reader/writer control section reads the data stored in the memory section via the contact type interface and the contact; and the communication control section transmits the read data to the mobile network.

6. The portable telephone set according to claim 5, wherein the data that the external system writes into the memory section is various kinds of service data for the user to receive various kinds of services.

7. The portable telephone set according to claim 5, wherein the data that the external system writes into the memory section is service point data.

8. An IC card comprising:
a non-contact type interface for performing transmission/reception of data with an external system via a radio link; and
a contact type interface operating independently of the non-contact type interface, for performing transmission/reception of data with a portable telephone body via a physical contact.
